(19) United States
(12) Patent Application Publication
(10) Pub. No.: US 2021/0373285 A1
(43) Pub. Date: Dec. 2, 2021

(54) CAMERA OPTICAL LENS

(71) Applicant: AAC Optics (Changzhou) Co., Ltd., Changzhou City (CN)

(72) Inventor: Haichao Peng, Shenzhen (CN)

(21) Appl. No.: 17/131,777

(22) Filed: Dec. 23, 2020

(30) Foreign Application Priority Data
May 27, 2020 (CN) 202010458134.3

(51) Int. Cl. G02B 13/00; G02B 9/36; G02B 27/00; G02B 1/04

(52) U.S. Cl. CPC G02B 13/004; G02B 1/041; G02B 27/0025; G02B 9/36

(57) ABSTRACT

A camera optical lens includes, from an object side to an image side, a first lens having a positive refractive power, a second lens having a negative refractive power, a third lens having a negative refractive power, and a fourth lens having a positive refractive power. 2.70≤v1/v4≤4.30, −1.20≤f2/f≤−0.50, −0.80≤f3/f≤−0.30, −10.00≤(R7+R8)/(R7−R8)≤−2.00, and 3.00≤d4/d5≤10.00. f denotes a focal length of the camera optical lens. f2 denotes a focal length of the second lens. f3 denotes a focal length of the third lens. v1 denotes an abbe number of the first lens. v4 denotes an abbe number of the fourth lens. R7 denotes a curvature radius of an object-side surface of the fourth lens. R8 denotes a curvature radius. d4 denotes an on-axis distance. d5 denotes an on-axis thickness of the third lens. The camera optical lens can achieve a good optical performance while being ultra-thin and having a long-focal-length.

### TECHNICAL FIELD

The present disclosure relates to the field of optical lens, and more particularly, to a camera optical lens suitable for handheld terminal devices such as smart phones or digital cameras and suitable for camera devices such as monitors or PC lenses.

### BACKGROUND

With the emergence of smart phones in recent years, the demand for miniature camera lens is increasing day by day, but in general the photosensitive devices of camera lens are nothing more than charge coupled device (CCD) or complementary metal-oxide semiconductor sensor (CMOS sensor), and as the progress of the semiconductor manufacturing technology makes the pixel size of the photosensitive devices become smaller, plus the current development trend of electronic products towards better functions and thinner and smaller dimensions, miniature camera lenses with good imaging quality therefore have become a mainstream in the market.

In order to obtain better imaging quality, the lens that is traditionally equipped in mobile phone cameras adopts a three-piece lens structure. Also, with the development of technology and the increase of the diverse demands of users, and as the pixel area of photosensitive devices is becoming smaller and smaller and the requirement of the system on the imaging quality is improving constantly, an four-piece lens structure gradually appears in lens designs. Although the common four-piece lens has good optical performance, its settings on refractive power, lens spacing, lens shape and dispersion coefficient still have some irrationality, which results in that the lens structure cannot achieve a high optical performance while satisfying design requirements for ultra-thin, long-focal-length lenses.

### SUMMARY

In view of the problems, the present disclosure aims to provide a camera optical lens, which can achieve high optical performance while satisfying design requirements for ultra-thin, long-focal-length lenses.

In an embodiment, the present disclosure provides a camera optical lens. The camera optical lens includes a first lens having a positive refractive power, a second lens having a negative refractive power, a third lens having a negative refractive power, and a fourth lens having a positive refractive power that are sequentially arranged from an object side to an image side. The camera optical lens satisfies: 2.70≤v1/v4≤4.30; −1.20≤f2/f≤−0.50; −0.80≤f3/f≤−0.30; −10.00≤(R7+R8)/(R7−R8)≤−2.00; and 3.00≤d4/d5≤10.00, where f denotes a focal length of the camera optical lens; f2 denotes a focal length of the second lens; f3 denotes a focal length of the third lens; v1 denotes an abbe number of the first lens; v4 denotes an abbe number of the fourth lens; R7 denotes a curvature radius of an object-side surface of the fourth lens; R8 denotes a curvature radius of an image-side surface of the fourth lens; d4 denotes an on-axis distance from an image-side surface of the second lens to an object-side surface of the third lens; and d5 denotes an on-axis thickness of the third lens.

As an improvement, the camera optical lens satisfies: R3/d3≤−15.00, where R3 denotes a curvature radius of an object-side surface of the second lens, and d3 denotes an of the second lens.

As an improvement, the camera optical lens satisfies: −1.00≤R1/R2≤0, where R1 denotes a curvature radius of an object-side surface of the first lens; and R2 denotes a curvature radius of an image-side surface of the first lens.

As an improvement, the camera optical lens satisfies: 0.19≤f1/f≤0.71, −1.98≤(R1+R2)/(R1−R2)≤0, and 0.08≤d1/TTL≤0.25, where f1 denotes a focal length of the first lens; R1 denotes a curvature radius of an object-side surface of the first lens; R2 denotes a curvature radius of an image-side surface of the first lens; d1 denotes an of the first lens; and TTL denotes a total optical length from the object-side surface of the first lens to an image plane of the camera optical lens along an optic axis.

As an improvement, the camera optical lens satisfies: −2.46≤(R3+R4)/(R3−R4)≤1.50 and 0.02≤d3/TTL≤0.10, where R3 denotes a curvature radius of an object-side surface of the second lens; R4 denotes a curvature radius of the image-side surface of the second lens; d3 denotes an of the second lens; and TTL denotes a total optical length from an object-side surface of the first lens to an image plane of the camera optical lens along an optic axis.

As an improvement, the camera optical lens satisfies: −6.22≤(R5+R6)/(R5−R6)≤0.41 and 0.01≤d5/TTL≤0.07, where R5 denotes a curvature radius of the object-side surface of the third lens; R6 denotes a curvature radius of an image-side surface of the third lens; and TTL denotes a total optical length from an object-side surface of the first lens to an image plane of the camera optical lens along an optic axis.

As an improvement, the camera optical lens satisfies: 0.24≤f4/f≤2.73, and 0.02≤d7/TTL≤0.11, where f4 denotes a focal length of the fourth lens; d7 denotes an of the fourth lens; and TTL denotes a total optical length from an object-side surface of the first lens to an image plane of the camera optical lens along an optic axis.

As an improvement, the camera optical lens satisfies: the camera optical lens satisfies: f/TTL≥1.06, where TTL denotes a total optical length from an object-side surface of the first lens to an image plane of the camera optical lens along an optic axis.

As an improvement, the camera optical lens satisfies: 0.33≤f12/f≤1.18, where f12 denotes a combined focal length of the first lens and the second lens.

As an improvement, the first lens is made of a glass material.

The camera optical lens has excellent optical characteristics and is ultra-thin and has a long focal length, making it suitable for camera optical lens assembly of mobile phones and WEB camera optical lenses formed by camera elements for high pixel such as CCD and CMOS.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a structure of a camera optical lens in accordance with Embodiment 1 of the present disclosure;

FIG. 2 is a schematic diagram of a longitudinal aberration of the camera optical lens shown in FIG. 1;

FIG. 3 is a schematic diagram of a lateral color of the camera optical lens shown in FIG. 1;

FIG. 4 is a schematic diagram of a field curvature and a distortion of the camera optical lens shown in FIG. 1;

FIG. 5 is a schematic diagram of a structure of a camera optical lens in accordance with Embodiment 2 of the present disclosure;

FIG. 6 is a schematic diagram of a longitudinal aberration of the camera optical lens shown in FIG. 5;

FIG. 7 is a schematic diagram of a lateral color of the camera optical lens shown in FIG. 5;

FIG. 8 is a schematic diagram of a field curvature and a distortion of the camera optical lens shown in FIG. 5;

FIG. 9 is a schematic diagram of a structure of a camera optical lens in accordance with Embodiment 3 of the present disclosure;

FIG. 10 is a schematic diagram of a longitudinal aberration of the camera optical lens shown in FIG. 9;

FIG. 11 is a schematic diagram of a lateral color of the camera optical lens shown in FIG. 9;

FIG. 12 is a schematic diagram of a field curvature and a distortion of the camera optical lens shown in FIG. 9;

FIG. 13 is a schematic diagram of a structure of a camera optical lens in accordance with Embodiment 4 of the present disclosure;

FIG. 14 is a schematic diagram of a longitudinal aberration of the camera optical lens shown in FIG. 13;

FIG. 15 is a schematic diagram of a lateral color of the camera optical lens shown in FIG. 13; and

FIG. 16 is a schematic diagram of a field curvature and a distortion of the camera optical lens shown in FIG. 13.

### DESCRIPTION OF EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

### Embodiment 1

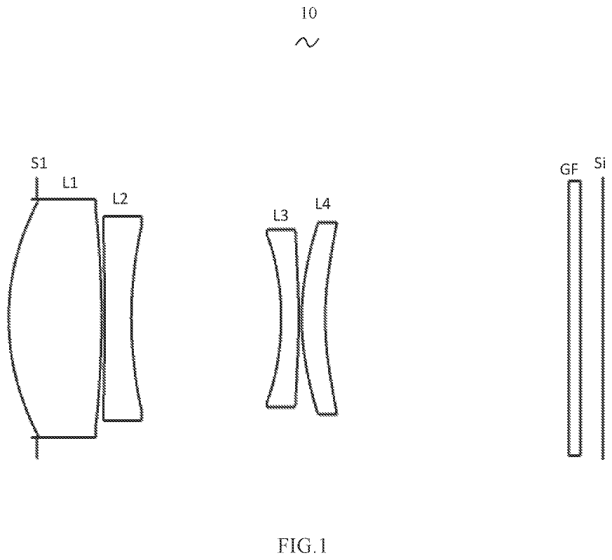

Referring to FIG. 1, the present disclosure provides a camera optical lens 10. FIG. 1 shows the camera optical lens 10 according to Embodiment 1 of the present disclosure. The camera optical lens 10 includes four lenses. Specifically, the camera optical lens 10 includes, from an object side to an image side, an aperture S1, a first lens L1, a second lens L2, a third lens L3, and a fourth lens L4. An optical element such as a glass filter (GF) can be arranged between the fourth lens L4 and an image plane Si. The glass filter GF can be a glass plate, or an optical filter. In other embodiments, the glass filter GF can be arranged in other positions.

The first lens L1 has a positive refractive power, the second lens L2 has a negative refractive power, the third lens L3 has a negative refractive power, and the fourth lens L4 has a positive refractive power.

As an example, the first lens L1 is made of a plastic material, the second lens L2 is made of a plastic material, the third lens L3 is made of a plastic material, and the fourth lens L4 is made of a plastic material.

An abbe number of the first lens L1 is defined as v1, an abbe number of the fourth lens L4 is defined as v4, a focal length of the camera optical lens 10 is defined as f, a focal length of the second lens L2 is defined as f2, a focal length of the third lens L3 is defined as f3, a curvature radius of an object-side surface of the four lens L4 is defined as R7, a curvature radius of an image-side surface of the fourth lens L4 is defined as R8, an on-axis distance from an image-side surface of the second lens L2 to an object-side surface of the third lens L3 is defined as d4, and an on-axis thickness of the third lens L3 is defined as d5. The camera optical lens 10 satisfies:

2.70≤v1/v4≤4.30 (1);

−1.20≤f2/f≤−0.50 (2);

−0.80≤f3/f≤−0.30 (3);

−10.00≤(R7+R8)/(R7−R8)≤−2.00 (4); and

3.00≤d4/d5≤10.00 (5).

The condition (1) specifies a ratio of a dispersion coefficient of the first lens L1 to a dispersion coefficient of the fourth lens L4, and this condition can effectively reduce aberration.

The condition (2) specifies a ratio of the focal length f2 of the second lens L2 to the focal length f of the system, which can effectively balance a spherical aberration and a field curvature of the system.

The condition (3) specifies a ratio of the focal length f3 of the third lens L3 to the focal length f of the system. Through reasonable setting of the refractive power, the system can have a better imaging quality and a lower sensitivity.

The condition (4) specifies a shape of the fourth lens L4. This can facilitate correction of an off-axis aberration with development towards ultra-thin lenses.

The condition (5) specifies a ratio of the on-axis distance d4 between the image-side surface of the second lens L2 and the object-side surface of the third lens L3 to the on-axis thickness d5 of the third lens L3. This condition facilitates to compress a total length of the optical system and achieve an ultra-thin effect.

As an example, a curvature radius of an object-side surface of the second lens L2 is defined as R3, an on-axis thickness of the second lens L2 is defined as d3, and the camera optical lens 10 satisfies a condition of R3/d3≤−15.00, which specifies a ratio of the curvature radius R3 of the object-side surface of the second lens L2 to the on-axis thickness d3 of the second lens L2. This condition facilitates improving the performance of the optical system.

As an example, a curvature radius of an object-side surface of the first lens L1 is defined as R1, a curvature radius of an image-side surface of the first lens L1 is defined as R2, and the camera optical lens 10 satisfies a condition of −1.00≤R1/R2≤0, which specifies a shape of the first lens L1. This condition can alleviate deflection of light passing through the lens while effectively reducing aberrations.

In this embodiment, the first lens L1 includes the object-side surface being convex in a paraxial region and the image-side surface being convex in the paraxial region.

As an example, a focal length of the camera optical lens 10 is defined as f, a focal length of the first lens L1 is defined as f1, and the camera optical lens 10 satisfies a condition of 0.19≤f1/f≤0.71, which specifies a ratio of the focal length f1 of the first lens L1 to the focal length f of the system. When the condition is satisfied, the first lens L1 can have an appropriate positive refractive power, thereby reducing aberrations of the system while facilitating development towards ultra-thin lenses. As an example, 0.30≤f1/f≤0.57.

As an example, a curvature radius of the object-side surface of the first lens L1 is defined as R1, a curvature radius of the image-side surface of the first lens L1 is defined as R2, and the camera optical lens 10 satisfies a condition of −1.98≤(R1+R2)/(R1−R2)≤0. This can reasonably control a shape of the first lens L1, so that the first lens L1 can effectively correct spherical aberrations of the system. As an example, −1.24≤(R1+R2)/(R1−R2)≤0.

As an example, an on-axis thickness of the first lens L1 is defined as d1, and a total optical length from the object-side surface of the first lens L1 to an image plane of the camera optical lens 10 along an optic axis is defined as TTL. The camera optical lens 10 satisfies a condition of 0.08≤d1/TTL≤0.25. This can facilitate achieving ultra-thin lenses. As an example, 0.12≤d1/TTL≤0.20.

In this embodiment, the second lens L2 includes an object-side surface being concave in a paraxial region and an image-side surface being concave in the paraxial region.

As an example, a curvature radius of the object-side surface of the second lens L2 is defined as R3, and a curvature radius of the image-side surface of the second lens L2 is defined as R4. The camera optical lens 10 satisfies a condition of −2.46≤(R3+R4)/(R3−R4)≤1.50, which specifies a shape of the second lens L2. This can facilitate correction of an on-axis aberration with development towards ultra-thin lenses. As an example, −1.54≤(R3+R4)/(R3−R4)≤1.20.

As an example, a total optical length from the object-side surface of the first lens L1 to an image plane of the camera optical lens 10 along an optic axis is defined as TTL, and an on-axis thickness of the second lens L2 is defined as d3. The camera optical lens 10 satisfies a condition of 0.02≤d3/TTL≤0.10. This can facilitate achieving ultra-thin lenses. As an example, 0.03≤d3/TTL≤0.08.

The third lens L3 includes an object-side surface being concave in a paraxial region and an image-side surface being convex in the paraxial region.

As an example, a curvature radius of the object-side surface of the third lens L3 is defined as R5, and a curvature radius of the image-side surface of the third lens L3 is defined as R6. The camera optical lens 10 satisfies a condition of −6.22≤(R5+R6)/(R5−R6)≤0.41. This can effectively control a shape of the third lens L3, thereby facilitating shaping of the third lens L3. This condition can alleviate the deflection of light passing through the lens while effectively reducing aberrations. As an example, −3.89≤(R5+R6)/(R5−R6)≤0.33.

As an example, an on-axis thickness of the third lens L3 is defined as d5, the total optical length from the object-side surface of the first lens L1 to an image plane of the camera optical lens 10 along an optic axis is defined as TTL, and the camera optical lens 10 satisfies a condition of 0.01≤d5/TTL≤0.07. This can facilitate achieving ultra-thin lenses. As an example, 0.02≤d5/TTL≤0.06.

The fourth lens L4 includes an object-side surface being convex in a paraxial region and an image-side surface being concave in the paraxial region.

As an example, the focal length of the camera optical lens 10 is f, a focal length of the fourth lens L4 is f4, and the camera optical lens 10 satisfies a condition of 0.24≤f4/f≤2.73. Through reasonable setting of the positive refractive power, the system can have a better imaging quality and a lower sensitivity. As an example, 0.39≤f4/f≤2.18.

As an example, the total optical length from the object-side surface of the first lens L1 to an image plane of the camera optical lens 10 along an optic axis is defined as TTL, an on-axis thickness of the fourth lens L4 is defined as d7, and the camera optical lens 10 satisfies a condition of 0.02≤d7/TTL≤0.11. This can facilitate achieving ultra-thin lenses. As an example, 0.03≤d7/TTL≤0.09.

As an example, the focal length of the camera optical lens 10 is f, the total optical length of the camera optical lens 10 is defined as TTL, and the camera optical lens 10 satisfies a condition of f/TTL≥1.06. This condition can facilitate achieving ultra-thin lenses. As an example, the focal length of the camera optical lens 10 is defined as f, a combined focal length of the first lens L1 and the second lens L2 as defined as f12, and the camera optical lens 10 satisfies a condition of 0.33≤f12/f≤1.18. This can eliminate aberration and distortion of the camera optical lens 10, suppress the back focal length of the camera optical lens 10, and maintain miniaturization of the camera lens system group. As an example, 0.52≤f12/f≤0.94.

When the above conditions are satisfied, the camera optical lens 10 will have high optical performance while satisfying design requirements for long-focal-length lenses. With these characteristics, the camera optical lens 10 is especially suitable for camera optical lens assembly of mobile phones and WEB camera optical lenses formed by imaging elements for high pixel such as CCD and CMOS.

In the following, examples will be used to describe the camera optical lens 10 of the present disclosure. The symbols recorded in each example will be described as follows. The focal length, on-axis distance, curvature radius, on-axis thickness, inflexion point position, and arrest point position are all in units of mm.

TTL: Optical length (the total optical length from the object-side surface of the first lens L1 to the image plane Si of the camera optical lens along the optic axis), in a unit of mm.

F number (FNO): a ratio of an effective focal length of the camera optical lens to an entrance pupil diameter of the camera optical lens.

In an example, inflexion points and/or arrest points can be arranged on the object-side surface and/or image-side surface of the lens, so as to satisfy the demand for the high quality imaging. The description below can be referred to for specific implementations.

Table 1 shows design data of the camera optical lens 10 according to Embodiment 1 of the present disclosure.

TABLE 1

| | R | d | | nd | | vd | |
|---|---|---|---|---|---|---|---|
| S1 | ∞ | d0= | −0.493 | | | | |
| R1 | 2.950 | d1= | 1.607 | nd1 | 1.5346 | v1 | 55.69 |
| R2 | −10.002 | d2= | 0.052 | | | | |
| R3 | −39.964 | d3= | 0.463 | nd2 | 1.6359 | v2 | 23.82 |
| R4 | 4.611 | d4= | 2.595 | | | | |
| R5 | −3.029 | d5= | 0.300 | nd3 | 1.5346 | v3 | 55.69 |
| R6 | −9.087 | d6= | 0.050 | | | | |
| R7 | 2.762 | d7= | 0.409 | nd4 | 1.6610 | v4 | 20.53 |
| R8 | 3.461 | d8= | 4.210 | | | | |
| R9 | ∞ | d9= | 0.210 | ndg | 1.5168 | vg | 64.17 |
| R10 | ∞ | d10= | 0.384 | | | | |

In the table, meanings of various symbols will be described as follows.

R: central curvature radius for a lens;

S1: aperture;

R1: curvature radius of the object-side surface of the first lens L1;

R2: curvature radius of the image-side surface of the first lens L1;

R3: curvature radius of the object-side surface of the second lens L2;

R4: curvature radius of the image-side surface of the second lens L2;

R5: curvature radius of the object-side surface of the third lens L3;

R6: curvature radius of the image-side surface of the third lens L3;

R7: curvature radius of the object-side surface of the fourth lens L4;

R8: curvature radius of the image-side surface of the fourth lens L4;

R9: curvature radius of an object-side surface of the glass filter GF;

R10: curvature radius of an image-side surface of the glass filter GF;

d: on-axis thickness of a lens, an on-axis distance between lenses;

d0: on-axis distance from the aperture S1 to the object-side surface of the first lens L1;

d1: on-axis thickness of the first lens L1;

d2: on-axis distance from the image-side surface of the first lens L1 to the object-side surface of the second lens L2;

d3: on-axis thickness of the second lens L2;

d4: on-axis distance from the image-side surface of the second lens L2 to the object-side surface of the third lens L3;

d5: on-axis thickness of the third lens L3;

d6: on-axis distance from the image-side surface of the third lens L3 to the object-side surface of the fourth lens L4;

d7: on-axis thickness of the fourth lens L4;

d8: on-axis distance from the image-side surface of the fourth lens L4 to the object-side surface of the glass filter GF;

d9: on-axis thickness of the glass filter GF;

d10: on-axis distance from the image-side surface of the glass filter GF to the image plane Si;

nd: refractive index of d line (the d line is green light with a wavelength of 550 nm);

nd1: refractive index of d line of the first lens L1;

nd2: refractive index of d line of the second lens L2;

nd3: refractive index of d line of the third lens L3;

nd4: refractive index of d line of the fourth lens L4;

ndg: refractive index of d line of the glass filter GF;

vd: abbe number;

v1: abbe number of the first lens L1;

v2: abbe number of the second lens L2;

v3: abbe number of the third lens L3;

v4: abbe number of the fourth lens L4;

vg: abbe number of the glass filter GF.

Table 2 shows aspherical data of respective lens in the camera optical lens 10 according to Embodiment 1 of the present disclosure.

TABLE 2

| | Conic coefficient | Aspherical coefficients | | | | |
|---|---|---|---|---|---|---|
| | k | A4 | A6 | A8 | A10 | A12 |
| R1 | 7.3362E−01 | −4.5863E−03 | −1.1312E−03 | 3.1692E−04 | −5.1845E−04 | 2.3093E−04 |
| R2 | −3.7350E+01 | 8.6135E−03 | 6.0056E−03 | −3.2259E−02 | 3.4715E−02 | −1.6983E−02 |
| R3 | −7.9181E+01 | −1.3594E−03 | 1.4588E−02 | −3.9406E−02 | 4.2076E−02 | −2.0876E−02 |
| R4 | −2.0332E+01 | 1.0474E−02 | −1.2491E−03 | −4.0593E−03 | 6.4620E−03 | −2.3828E−03 |
| R5 | −1.5300E+00 | 2.1750E−02 | −5.3825E−02 | 7.5119E−02 | −9.4299E−02 | 7.7473E−02 |
| R6 | 2.7858E+01 | 3.6797E−02 | −5.0770E−02 | 7.4751E−02 | −6.5720E−02 | 3.4696E−02 |
| R7 | 4.6435E−01 | −3.6691E−02 | −4.6656E−03 | 1.6221E−02 | −6.0466E−03 | −3.2278E−03 |
| R8 | −1.7460E+01 | 1.8721E−02 | −2.3442E−02 | 1.0568E−02 | 7.1832E−03 | −1.0603E−02 |

| | |
|---|---|
| Conic coefficient | Aspherical coefficients |

| | k | A14 | A16 |
|---|---|---|---|
| R1 | 7.3362E−01 | −5.1483E−05 | 3.6740E−06 |
| R2 | −3.7350E+01 | 3.9378E−03 | −3.5194E−04 |
| R3 | −7.9181E+01 | 4.8641E−03 | −4.2663E−04 |
| R4 | −2.0332E+01 | −2.3838E−04 | 1.9665E−04 |
| R5 | −1.5300E+00 | −3.4607E−02 | 6.2378E−03 |
| R6 | 2.7858E+01 | −1.0223E−02 | 1.2748E−03 |
| R7 | 4.6435E−01 | 2.6500E−03 | −4.9203E−04 |
| R8 | −1.7460E+01 | 4.5037E−03 | −6.6621E−04 |

In Table 2, k is a conic coefficient, and A4, A6, A8, A10, A12, A14 and A16 are aspherical coefficients.

y=(x²/R)/{1+[1−(1+k)(x²/R²)]^{1/2}}+A4x⁴+A6x⁶+A8x⁸+A10x¹⁰+A12x¹²+A14x¹⁴+A16x¹⁶ (6),

where x is a vertical distance between a point on an aspherical curve and the optic axis, and y is an aspherical depth (a vertical distance between a point on an aspherical surface, having a distance of x from the optic axis, and a surface tangent to a vertex of the aspherical surface on the optic axis).

It should be noted that the aspherical surface of each lens in this embodiment preferably uses the aspherical surface shown in the following condition (6), but the specific form of the following condition (6) is only an example, and actually, it is not limited to the aspherical polynomial form shown in the condition (6).

Table 3 shows design data of inflexion points and arrest points of respective lens in the camera optical lens 10 according to Embodiment 1 of the present disclosure. P1R1 and P1R2 represent the object-side surface and the image-side surface of the first lens L1, respectively; P2R1 and P2R2 represent the object-side surface and the image-side surface of the second lens L2, respectively; P3R1 and P3R2 represent the object-side surface and the image-side surface of the third lens L3, respectively; and P4R1 and P4R2 represent the object-side surface and the image-side surface of the fourth lens L4, respectively. The data in the column “inflexion point position” refers to vertical distances from inflexion points arranged on each lens surface to the optic axis of the camera optical lens 10.

TABLE 3

| | Number of | Inflexion point | Inflexion point |
|---|---|---|---|
| | inflexion points | position 1 | position 2 |
| P1R1 | 0 | / | / |
| P1R2 | 0 | / | / |
| P2R1 | 1 | 0.995 | / |
| P2R2 | 0 | / | / |
| P3R1 | 0 | / | / |
| P3R2 | 2 | 0.925 | 1.075 |
| P4R1 | 0 | / | / |
| P4R2 | 0 | / | / |

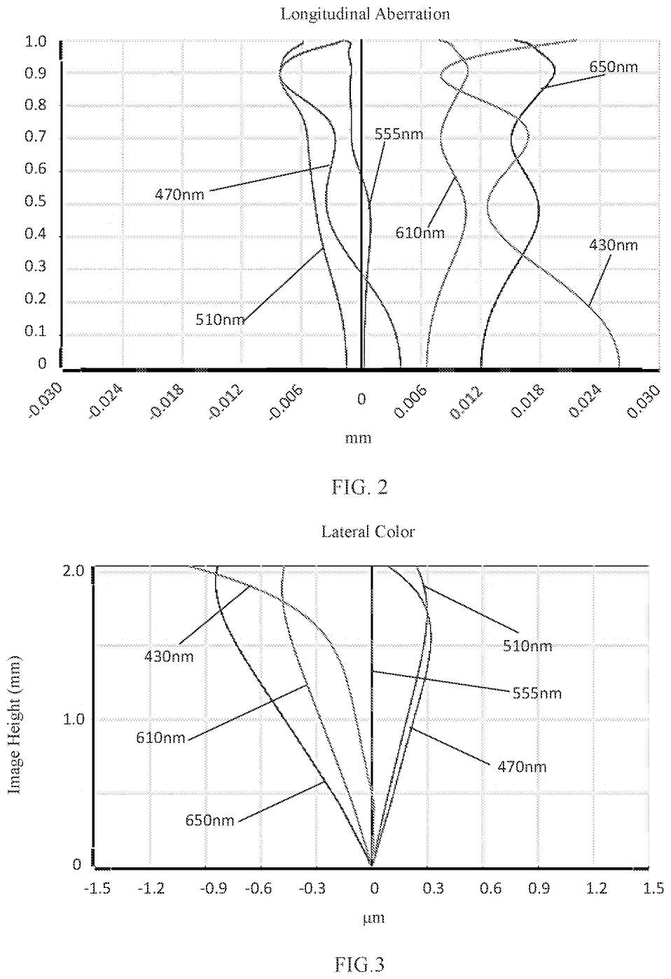

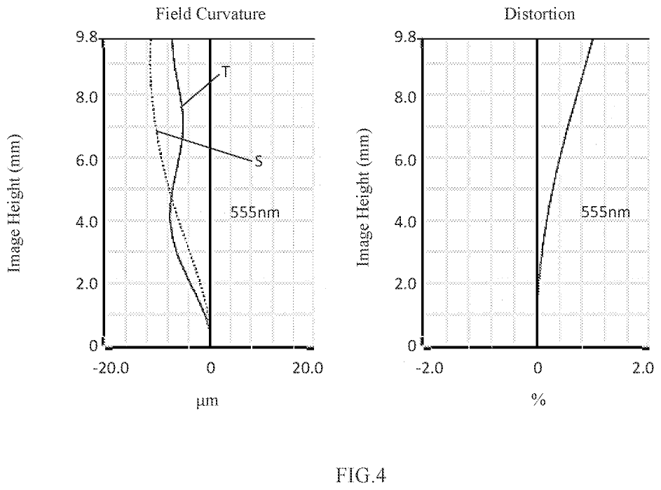

FIG. 2 and FIG. 3 illustrate a longitudinal aberration and a lateral color of light with wavelengths of 650 nm, 610 nm, 555 nm, 510 nm, 470 nm and 430 nm after passing the camera optical lens 10 according to Embodiment 1. FIG. 4 illustrates a field curvature and a distortion of light with a wavelength of 555 nm after passing the camera optical lens 10 according to Embodiment 1, in which a field curvature S is a field curvature in a sagittal direction and T is a field curvature in a tangential direction.

Table 16 below further lists various values of Embodiments 1, 2, 3, and 4 and values corresponding to parameters which are specified in the above conditions.

As shown in Table 16, Embodiment 1 satisfies the respective conditions.

In this embodiment, the entrance pupil diameter ENPD of the camera optical lens is 3.442 mm. The image height IH is 2.040 mm. The field of view (FOV) along a diagonal direction is 19.60°. Thus, the camera optical lens 10 satisfies design requirements of long-focal-length and ultra-thin while having on-axis and off-axis aberrations sufficiently corrected, thereby leading to better optical characteristics.

### Embodiment 2

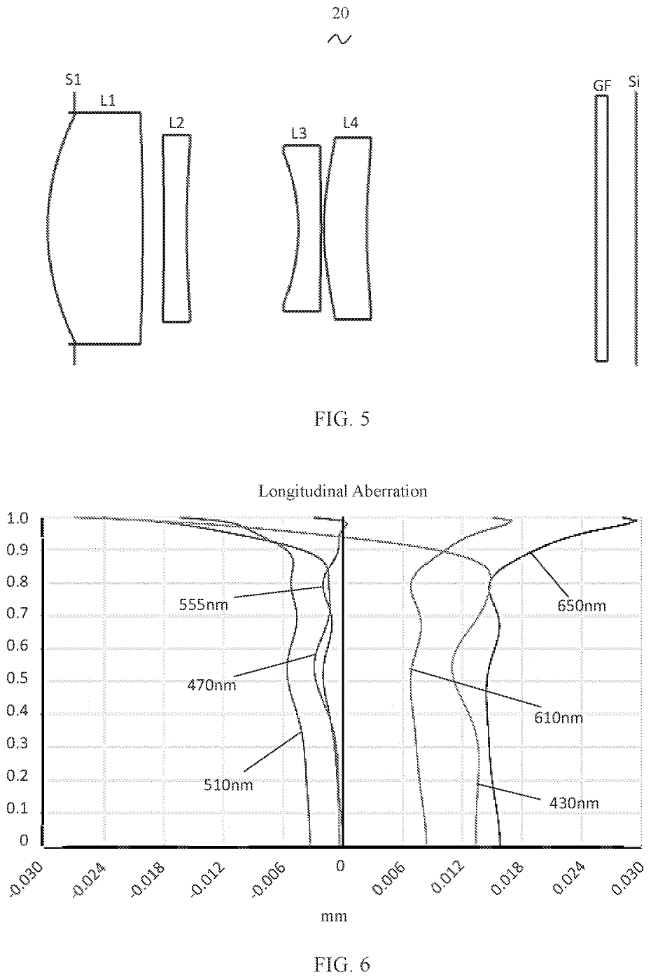

FIG. 5 is a structural schematic diagram of a camera optical lens 20 in Embodiment 2. Embodiment 2 is basically the same as Embodiment 1 and involves symbols having the same meanings as Embodiment 1. Only differences therebetween will be described in the following.

In this embodiment, the first lens L1 is made of a glass material, the second lens L2 is made of a plastic material, the third lens L3 is made of a plastic material, and the fourth lens L4 is made of a plastic material.

Table 4 shows design data of the camera optical lens 20 in Embodiment 2 of the present disclosure.

TABLE 4

| | R | d | | nd | | vd | |
|---|---|---|---|---|---|---|---|
| S1 | ∞ | d0= | −0.464 | | | | |
| R1 | 3.036 | d1= | 1.660 | nd1 | 1.5267 | v1 | 76.60 |
| R2 | −46.000 | d2= | 0.374 | | | | |
| R3 | −23.693 | d3= | 0.396 | nd2 | 1.6610 | v2 | 20.53 |
| R4 | 13.337 | d4= | 1.951 | | | | |
| R5 | −2.284 | d5= | 0.395 | nd3 | 1.5661 | v3 | 37.71 |
| R6 | −14.995 | d6= | 0.050 | | | | |
| R7 | 3.282 | d7= | 0.748 | nd4 | 1.6610 | v4 | 20.53 |
| R8 | 7.158 | d8= | 4.000 | | | | |
| R9 | ∞ | d9= | 0.210 | ndg | 1.5168 | vg | 64.17 |
| R10 | ∞ | d10= | 0.496 | | | | |

Table 5 shows aspherical data of respective lenses in the camera optical lens 20 according to Embodiment 2 of the present disclosure.

TABLE 5

| | Conic coefficient | Aspherical coefficients | | | | |
|---|---|---|---|---|---|---|
| | k | A4 | A6 | A8 | A10 | A12 |
| R1 | 7.0686E−01 | −6.2502E−03 | −5.3615E−04 | 3.4997E−04 | −6.8512E−04 | 3.1995E−04 |
| R2 | 7.6453E+01 | −1.8892E−03 | 4.2392E−03 | −3.3375E−03 | −2.3020E−03 | 3.2433E−03 |
| R3 | −9.8330E+01 | 9.0443E−03 | −4.7180E−04 | 7.6283E−04 | −1.3594E−02 | 1.5574E−02 |
| R4 | −9.8979E+01 | 1.1894E−02 | −1.0602E−02 | 1.4913E−02 | −2.9744E−02 | 2.8967E−02 |
| R5 | −4.1908E+00 | 4.5413E−02 | −1.8994E−01 | 3.3403E−01 | −4.1620E−01 | 3.3386E−01 |
| R6 | 4.8436E+01 | 7.7461E−02 | −1.8992E−01 | 2.8017E−01 | −2.5417E−01 | 1.5185E−01 |
| R7 | 5.3956E−01 | −3.0049E−02 | −3.6630E−02 | 6.4918E−02 | −4.9287E−02 | 2.2810E−02 |
| R8 | 2.0056E+00 | −2.6259E−02 | 2.4075E−02 | −3.4840E−02 | 3.0757E−02 | −1.5298E−02 |

| | |
|---|---|
| Conic coefficient | Aspherical coefficients |

| | k | A14 | A16 |
|---|---|---|---|
| R1 | 7.0686E−01 | −7.1961E−05 | 6.2112E−06 |
| R2 | 7.6453E+01 | −1.2246E−03 | 1.5969E−04 |
| R3 | −9.8330E+01 | −6.5762E−03 | 9.9746E−04 |
| R4 | −9.8979E+01 | −1.2709E−02 | 2.1094E−03 |
| R5 | −4.1908E+00 | −1.4976E−01 | 2.7972E−02 |
| R6 | 4.8436E+01 | −5.3982E−02 | 8.2531E−03 |
| R7 | 5.3956E−01 | −6.5390E−03 | 8.2200E−04 |
| R8 | 2.0056E+00 | 3.9827E−03 | −4.3479E−04 |

Table 6 and Table 7 show design data of inflexion points and arrest points of respective lens in the camera optical lens 20 according to an embodiment of the present disclosure. The data in the column named “arrest point position” refers to vertical distances from arrest points arranged on each lens surface to the optic axis of the camera optical lens 20.

TABLE 6

| | Number of | Inflexion point | Inflexion point |
|---|---|---|---|
| | inflexion points | position 1 | position 2 |
| P1R1 | 0 | / | / |
| P1R2 | 1 | 1.455 | / |
| P2R1 | 1 | 1.075 | / |
| P2R2 | 0 | / | / |
| P3R1 | 0 | / | / |
| P3R2 | 2 | 0.775 | 1.155 |
| P4R1 | 1 | 1.195 | / |
| P4R2 | 1 | 0.905 | / |

TABLE 7

| | Number of arrest points | Arrest point position 1 |
|---|---|---|
| P1R1 | 0 | / |
| P1R2 | 0 | / |
| P2R1 | 1 | 1.325 |
| P2R2 | 0 | / |
| P3R1 | 0 | / |
| P3R2 | 1 | 1.045 |
| P4R1 | 0 | / |
| P4R2 | 0 | / |

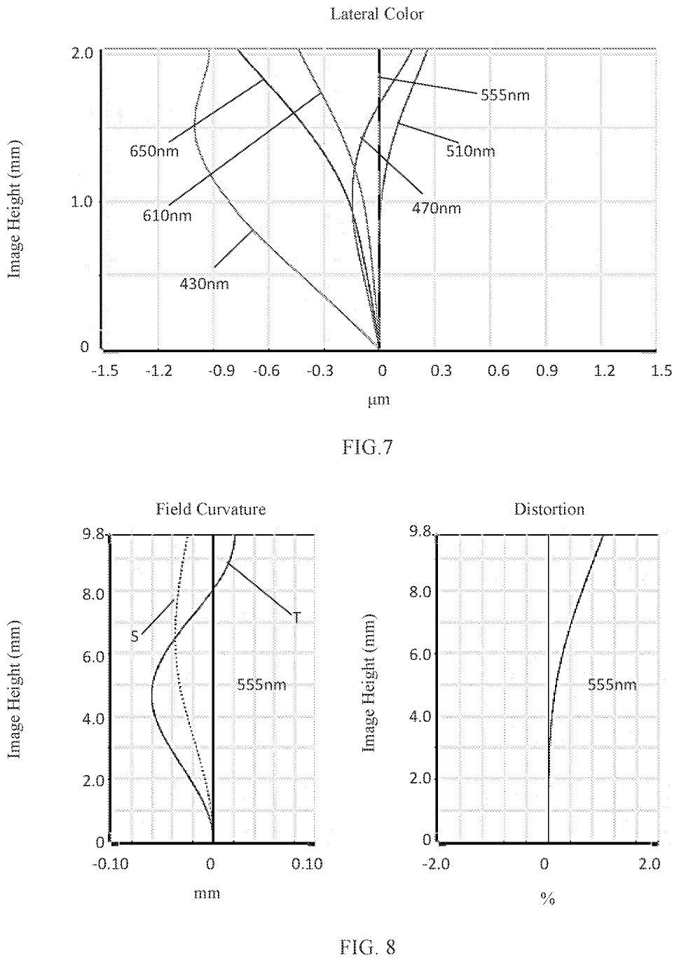

FIG. 6 and FIG. 7 illustrate a longitudinal aberration and a lateral color of light with wavelengths of 650 nm, 610 nm, 555 nm, 510 nm, 470 nm and 430 nm after passing the camera optical lens 20 according to Embodiment 2. FIG. 8 illustrates a field curvature and a distortion of light with a wavelength of 555 nm after passing the camera optical lens 20 according to Embodiment 2, in which a field curvature S is a field curvature in a sagittal direction and T is a field curvature in a tangential direction.

Table 16 below further lists various values of Embodiments 1, 2, 3, and 4 and values corresponding to parameters which are specified in the above conditions.

As shown in Table 16, Embodiment 2 satisfies the respective conditions.

In this embodiment, the entrance pupil diameter ENPD of the camera optical lens is 3.441 mm. The image height UT is 2.040 mm. The field of view (FOV) along a diagonal direction is 19.590. Thus, the camera optical lens 20 satisfies design requirements of long-focal-length and ultra-thin while having on-axis and off-axis aberrations sufficiently corrected, thereby leading to better optical characteristics.

### Embodiment 3

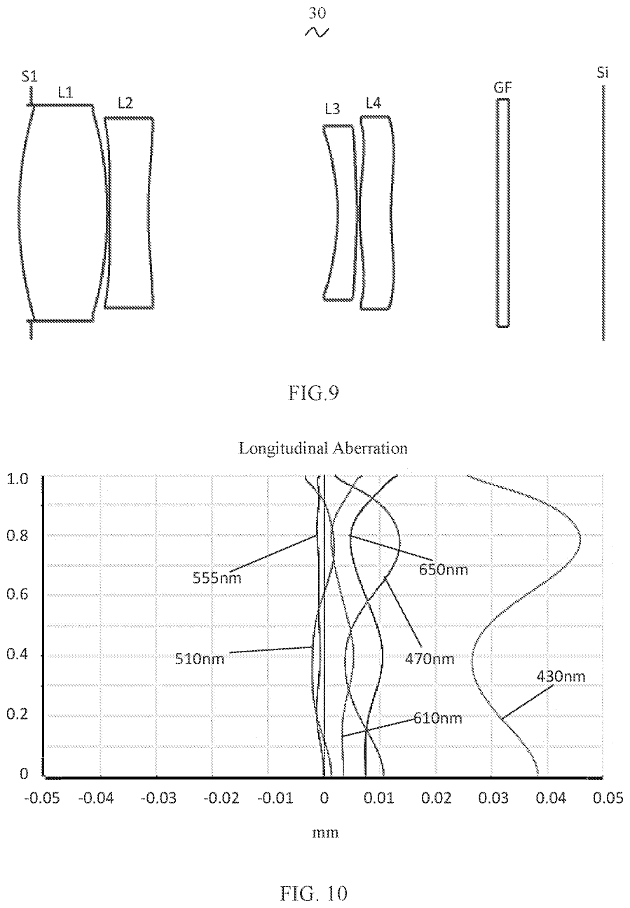

FIG. 9 is a structural schematic diagram of a camera optical lens 30 in Embodiment 3. Embodiment 3 is basically the same as Embodiment 1.

Table 8 shows design data of the camera optical lens 30 in Embodiment 3 of the present disclosure.

TABLE 8

| | R | d | | nd | | vd | |
|---|---|---|---|---|---|---|---|
| S1 | ∞ | d0= | −0.235 | | | | |
| R1 | 4.885 | d1= | 1.660 | nd1 | 1.5346 | v1 | 55.69 |
| R2 | −4.934 | d2= | 0.050 | | | | |
| R3 | −72000.000 | d3= | 0.720 | nd2 | 1.6359 | v2 | 23.82 |
| R4 | 5.170 | d4= | 3.571 | | | | |
| R5 | −2.297 | d5= | 0.359 | nd3 | 1.5346 | v3 | 55.69 |
| R6 | −4.476 | d6= | 0.050 | | | | |
| R7 | 3.397 | d7= | 0.590 | nd4 | 1.6610 | v4 | 20.53 |
| R8 | 4.156 | d8= | 2.000 | | | | |
| R9 | ∞ | d9= | 0.210 | ndg | 1.5168 | vg | 64.17 |
| R10 | ∞ | d10= | 1.790 | | | | |

Table 9 shows aspherical data of respective lenses in the camera optical lens 30 according to Embodiment 3 of the present disclosure.

TABLE 9

| | Conic coefficient | Aspherical coefficients | | | | |
|---|---|---|---|---|---|---|
| | k | A4 | A6 | A8 | A10 | A12 |
| R1 | 1.6271E+00 | −2.6404E−03 | −2.9938E−04 | 5.6201E−05 | −1.7075E−04 | 8.1828E−05 |
| R2 | −4.5541E+00 | 1.2207E−02 | −1.6978E−02 | 6.3359E−03 | −3.3400E−04 | −4.0751E−04 |
| R3 | 9.8999E+01 | −1.0434E−02 | −1.0703E−02 | 6.2083E−04 | 3.3127E−03 | −1.4789E−03 |
| R4 | −3.7456E+01 | 5.5497E−04 | −1.6641E−02 | 9.2237E−03 | −3.6785E−03 | 1.4543E−03 |
| R5 | −6.0830E+00 | 1.0688E−01 | −1.2247E−01 | 7.7256E−02 | −6.9583E−02 | 5.9036E−02 |
| R6 | 3.4475E+00 | 1.2385E−01 | −5.5275E−03 | −1.0333E−01 | 6.8890E−02 | −2.5894E−03 |
| R7 | −4.1861E+00 | −9.5498E−02 | 9.1755E−02 | −9.7642E−02 | 4.8227E−02 | −7.6679E−03 |
| R8 | −1.1663E+01 | −8.5598E−02 | 4.9630E−02 | −3.0598E−02 | 9.6231E−03 | −9.4336E−05 |

| | |
|---|---|
| Conic coefficient | Aspherical coefficients |

| | k | A14 | A16 |
|---|---|---|---|
| R1 | 1.6271E+00 | −1.7365E−05 | 1.2800E−06 |
| R2 | −4.5541E+00 | 1.0183E−04 | −6.8840E−06 |
| R3 | 9.8999E+01 | 2.1016E−04 | −3.3581E−06 |
| R4 | −3.7456E+01 | −4.5077E−04 | 6.3013E−05 |
| R5 | −6.0830E+00 | −2.6552E−02 | 4.5507E−03 |
| R6 | 3.4475E+00 | −9.4341E−03 | 2.0762E−03 |
| R7 | −4.1861E+00 | −8.1232E−04 | 1.0036E−04 |
| R8 | −1.1663E+01 | −7.1536E−04 | 1.1704E−04 |

Table 10 and Table 11 show design data of inflexion points and arrest points of respective lens in the camera optical lens 30 according to an embodiment of the present disclosure. The data in the column named “arrest point position” refers to vertical distances from arrest points arranged on each lens surface to the optic axis of the camera optical lens 30.

TABLE 10

| | Number of | Inflexion point | Inflexion point |
|---|---|---|---|
| | inflexion points | position 1 | position 2 |
| P1R1 | 0 | / | / |
| P1R2 | 0 | / | / |
| P2R1 | 0 | / | / |
| P2R2 | 1 | 0.745 | / |
| P3R1 | 0 | / | / |
| P3R2 | 2 | 0.435 | 0.795 |
| P4R1 | 1 | 0.615 | / |
| P4R2 | 1 | 0.515 | / |

TABLE 11

| | Number of arrest points | Arrest point position 1 |
|---|---|---|
| P1R1 | 0 | / |
| P1R2 | 0 | / |
| P2R1 | 0 | / |
| P2R2 | 1 | 1.365 |
| P3R1 | 0 | / |
| P3R2 | 0 | / |
| P4R1 | 1 | 1.055 |
| P4R2 | 1 | 0.965 |

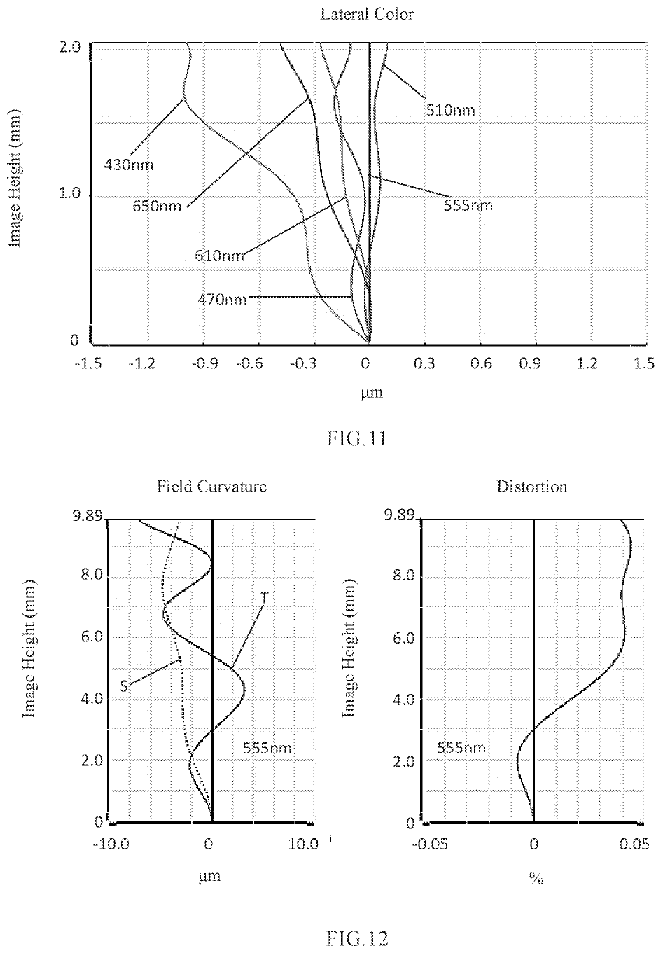

FIG. 10 and FIG. 11 illustrate a longitudinal aberration and a lateral color of light with wavelengths of 650 nm, 610 nm, 555 nm, 510 nm, 470 nm and 430 nm after passing the camera optical lens 30 according to Embodiment 3. FIG. 12 illustrates a field curvature and a distortion of light with a wavelength of 555 nm after passing the camera optical lens 30 according to Embodiment 3, in which a field curvature S is a field curvature in a sagittal direction and T is a field curvature in a tangential direction.

Table 16 below further lists various values of Embodiments 1, 2, 3, and 4 and values corresponding to parameters which are specified in the above conditions.

As shown in Table 16, Embodiment 3 satisfies the respective conditions.

In this embodiment, the entrance pupil diameter ENPD of the camera optical lens is 3.441 mm. The image height IH is 2.040 mm. The field of view (FOV) along a diagonal direction is 19.77°. Thus, the camera optical lens 30 satisfies design requirements of long-focal-length and ultra-thin while having on-axis and off-axis aberrations sufficiently corrected, thereby leading to better optical characteristics.

### Embodiment 4

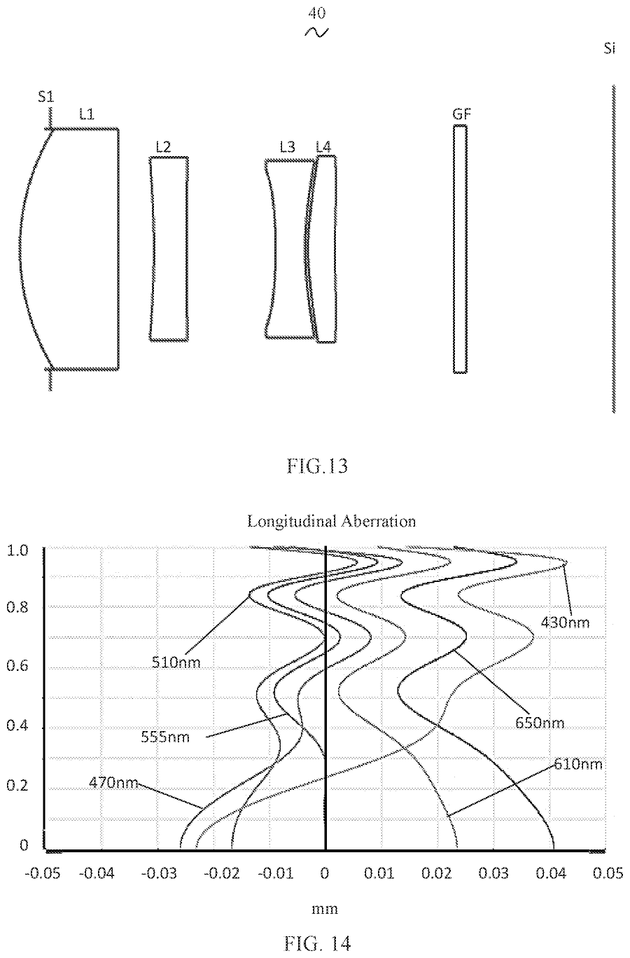

FIG. 13 is a structural schematic diagram of a camera optical lens 40 in Embodiment 4. Embodiment 4 is basically the same as Embodiment 1 and involves symbols having the same meanings as Embodiment 1. Only differences therebetween will be described in the following.

In this embodiment, the image-side surface of the second lens L2 is convex in the paraxial region, and the image-side surface of the third lens L3 is concave in the paraxial region.

In this embodiment, the first lens L1 is made of a glass material, the second lens L2 is made of a plastic material, the third lens L3 is made of a plastic material, and the fourth lens L4 is made of a plastic material.

Table 12 shows design data of the camera optical lens 40 in Embodiment 4 of the present disclosure.

TABLE 12

| | R | d | | nd | | vd | |
|---|---|---|---|---|---|---|---|
| S1 | ∞ | d0= | −0.513 | | | | |
| R1 | 2.768 | d1= | 1.660 | nd1 | 1.4970 | v1 | 81.61 |
| R2 | −553.572 | d2= | 0.599 | | | | |
| R3 | −8.360 | d3= | 0.550 | nd2 | 1.6610 | v2 | 20.53 |
| R4 | −81.370 | d4= | 1.496 | | | | |
| R5 | −5.723 | d5= | 0.495 | nd3 | 1.5661 | v3 | 37.71 |
| R6 | 3.244 | d6= | 0.050 | | | | |
| R7 | 2.652 | d7= | 0.451 | nd4 | 1.6700 | v4 | 19.30 |
| R8 | 7.850 | d8= | 2.000 | | | | |
| R9 | ∞ | d9= | 0.210 | ndg | 1.5168 | vg | 64.17 |
| R10 | ∞ | d10= | 2.490 | | | | |

Table 13 shows aspherical data of respective lenses in the camera optical lens 40 according to Embodiment 4 of the present disclosure.

TABLE 13

| | Conic coefficient | Aspherical coefficients | | | | |
|---|---|---|---|---|---|---|
| | k | A4 | A6 | A8 | A10 | A12 |
| R1 | 6.8121E−01 | −5.8805E−03 | −1.7564E−03 | 1.9484E−03 | −2.1275E−03 | 1.0178E−03 |
| R2 | −9.8996E+01 | −1.8048E−03 | 6.3498E−03 | −4.9961E−03 | −9.9660E−04 | 2.8005E−03 |
| R3 | −6.9706E+01 | −5.6382E−03 | 4.7903E−02 | −9.6441E−02 | 1.0002E−01 | −5.8628E−02 |
| R4 | −9.9000E+01 | 9.1816E−03 | 4.0713E−02 | −1.1432E−01 | 1.4573E−01 | −1.0436E−01 |
| R5 | 1.2274E+00 | −1.4117E−02 | 1.1796E−01 | −4.1598E−01 | 5.6408E−01 | −3.9281E−01 |
| R6 | −3.5866E+01 | −3.0062E−01 | 1.7192E+00 | −4.1525E+00 | 5.4472E+00 | −4.0223E+00 |
| R7 | −2.8762E+00 | −4.1846E−01 | 1.5563E+00 | −3.3690E+00 | 4.2081E+00 | −3.0023E+00 |
| R8 | −5.3252E+01 | −7.8633E−02 | 1.5598E−01 | −2.9244E−01 | 3.4451E−01 | −2.3377E−01 |

| | |
|---|---|
| Conic coefficient | Aspherical coefficients |

| | k | A14 | A16 |
|---|---|---|---|
| R1 | 6.8121E−01 | −2.4461E−04 | 2.2744E−05 |
| R2 | −9.8996E+01 | −1.2427E−03 | 1.8722E−04 |
| R3 | −6.9706E+01 | 1.8527E−02 | −2.4094E−03 |
| R4 | −9.9000E+01 | 4.0173E−02 | −6.3588E−03 |
| R5 | 1.2274E+00 | 1.3214E−01 | −1.5247E−02 |
| R6 | −3.5866E+01 | 1.5653E+00 | −2.4902E−01 |
| R7 | −2.8762E+00 | 1.1325E+00 | −1.7462E−01 |
| R8 | −5.3252E+01 | 8.3004E−02 | −1.1880E−02 |

Table 14 and Table 15 show design data of inflexion points and arrest points of respective lens in the camera optical lens 40 according to an embodiment of the present disclosure. The data in the column named “arrest point position” refers to vertical distances from arrest points arranged on each lens surface to the optic axis of the camera optical lens

TABLE 14

| | Number of | Inflexion point | Inflexion point | Inflexion point |
|---|---|---|---|---|
| | inflexion points | position 1 | position 2 | position 3 |
| P1R1 | 0 | / | / | / |
| P1R2 | 3 | 0.495 | 0.805 | 1.255 |
| P2R1 | 1 | 1.055 | / | / |
| P2R2 | 1 | 0.275 | / | / |
| P3R1 | 0 | / | / | / |
| P3R2 | 3 | 0.955 | 1.095 | 1.225 |
| P4R1 | 3 | 0.955 | 1.115 | 1.245 |
| P4R2 | 1 | 0.475 | / | / |

TABLE 15

| | Number of arrest points | Arrest point position 1 |
|---|---|---|
| P1R1 | 0 | / |
| P1R2 | 1 | 1.385 |
| P2R1 | 0 | / |
| P2R2 | 1 | 0.455 |
| P3R1 | 0 | / |
| P3R2 | 0 | / |
| P4R1 | 0 | / |
| P4R2 | 1 | 0.925 |

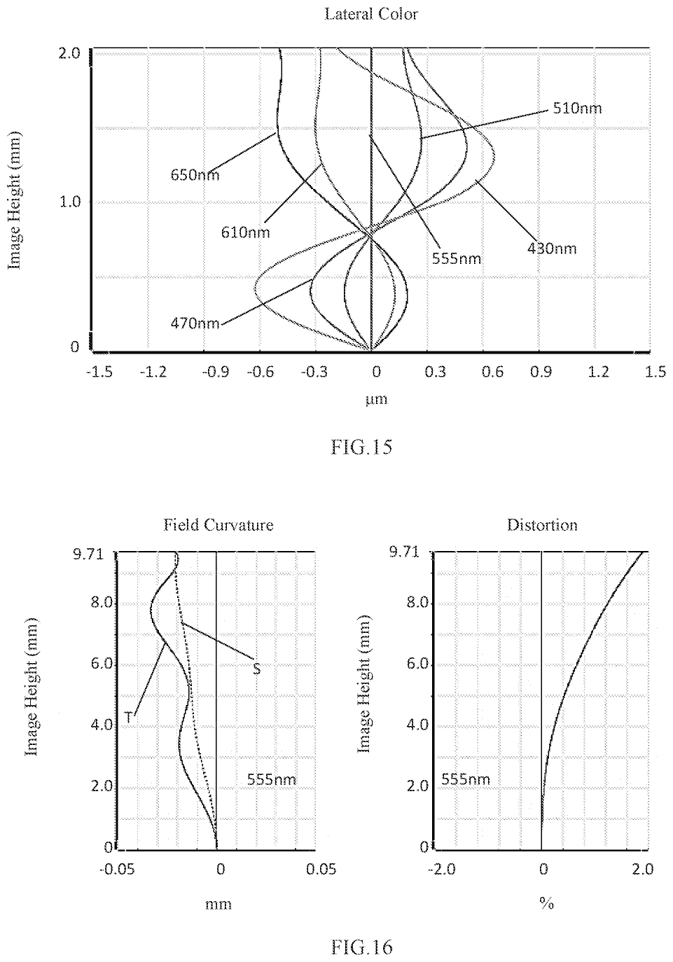

FIG. 14 and FIG. 15 illustrate a longitudinal aberration and a lateral color of light with wavelengths of 650 nm, 610 nm, 555 nm, 510 nm, 470 nm and 430 nm after passing the camera optical lens 40 according to Embodiment 4. FIG. 16 illustrates a field curvature and a distortion of light with a wavelength of 555 nm after passing the camera optical lens 40 according to Embodiment 4, in which a field curvature S is a field curvature in a sagittal direction and T is a field curvature in a tangential direction.

Table 16 below further lists various values of Embodiments 1, 2, 3, and 4 and values corresponding to parameters which are specified in the above conditions.

As shown in Table 16, Embodiment 4 satisfies the respective conditions.

In this embodiment, the entrance pupil diameter ENPD of the camera optical lens 40 is 3.441 mm. The image height UT is 2.040 mm. The field of view (FOV) along a diagonal direction is 19.42°. Thus, the camera optical lens 40 satisfies design requirements of long-focal-length and ultra-thin while having on-axis and off-axis aberrations sufficiently corrected, thereby leading to better optical characteristics.

Table 16 below further lists various values of the corresponding conditions as well as the values of other related parameters in Embodiment 1, Embodiment 2, Embodiment 3, and Embodiment 4.

TABLE 16

| Parameters and | Embodi- | Embodi- | Embodi- | Embodi- |
|---|---|---|---|---|
| Conditions | ment 1 | ment 2 | ment 3 | ment 4 |
| v1/v4 | 2.71 | 3.73 | 2.71 | 4.23 |
| f2/f | −0.55 | −1.09 | −0.69 | −1.20 |
| f3/f | −0.74 | −0.41 | −0.80 | −0.31 |
| (R7 + R8)/(R7 − R8) | −8.90 | −2.69 | −9.95 | −2.02 |
| d4/d5 | 8.65 | 4.94 | 9.95 | 3.02 |
| f | 11.704 | 11.700 | 11.700 | 11.699 |
| f1 | 4.440 | 5.458 | 4.864 | 5.534 |
| f2 | −6.426 | −12.744 | −8.068 | −14.017 |
| f3 | −8.622 | −4.792 | −9.337 | −3.569 |
| f4 | 16.628 | 8.441 | 21.278 | 5.721 |
| f12 | 9.101 | 7.867 | 9.190 | 7.645 |
| FNO | 3.40 | 3.40 | 3.40 | 3.40 |
| TTL | 10.280 | 10.280 | 11.000 | 10.001 |
| FOV | 19.60 | 19.59 | 19.77 | 19.42 |
| IH | 2.040 | 2.040 | 2.040 | 2.040 |

It can be appreciated by one having ordinary skill in the art that the description above is only embodiments of the present disclosure. In practice, one having ordinary skill in the art can make various modifications to these embodiments in forms and details without departing from the spirit and scope of the present disclosure.

What is claimed is:

1. A camera optical lens, comprising, from an object side to an image side:
a first lens having a positive refractive power;
a second lens having a negative refractive power;
a third lens having a negative refractive power; and
a fourth lens having a positive refractive power,
wherein the camera optical lens satisfies:
2.70≤v1/v4≤4.30;
−1.20≤f2/f≤−0.50;
−0.80≤f3/f≤−0.30;
−10.00≤(R7+R8)/(R7-R8)≤−2.00; and
3.00≤d4/d5≤10.00,
where f denotes a focal length of the camera optical lens; f2 denotes a focal length of the second lens; f3 denotes a focal length of the third lens; v1 denotes an abbe number of the first lens; v4 denotes an abbe number of the fourth lens; R7 denotes a curvature radius of an object-side surface of the fourth lens; R8 denotes a curvature radius of an image-side surface of the fourth lens; d4 denotes an on-axis distance from an image-side surface of the second lens to an object-side surface of the third lens; and d5 denotes an on-axis thickness of the third lens.

2. The camera optical lens as described in claim 1, wherein the camera optical lens satisfies: R3/d3≤−15.00, where R3 denotes a curvature radius of an object-side surface of the second lens, and d3 denotes an on-axis thickness of the second lens.

3. The camera optical lens as described in claim 1, wherein the camera optical lens satisfies: −1.00≤R1/R2≤0, where R1 denotes a curvature radius of an object-side surface of the first lens; and R2 denotes a curvature radius of an image-side surface of the first lens.

4. The camera optical lens as described in claim 1, wherein the camera optical lens satisfies:
0.19≤f1/f≤0.71;
−1.98≤(R1+R2)/(R1−R2)≤0; and
0.08≤d1/TTL≤0.25,
where f1 denotes a focal length of the first lens; R1 denotes a curvature radius of an object-side surface of the first lens; R2 denotes a curvature radius of an image-side surface of the first lens; d1 denotes an on-axis thickness of the first lens; and TTL denotes a total optical length from the object-side surface of the first lens to an image plane of the camera optical lens along an optic axis.

5. The camera optical lens as described in claim 1, wherein the camera optical lens satisfies:
−2.46≤(R3+R4)/(R3−R4)≤1.50; and
0.02≤d3/TTL≤0.10,
where R3 denotes a curvature radius of an object-side surface of the second lens; R4 denotes a curvature radius of the image-side surface of the second lens; d3 denotes an on-axis thickness of the second lens; and TTL denotes a total optical length from an object-side surface of the first lens to an image plane of the camera optical lens along an optic axis.

6. The camera optical lens as described in claim 1, wherein the camera optical lens satisfies:
−6.22≤(R5+R6)/(R5−R6)≤0.41; and
0.01≤d5/TTL≤0.07,
where R5 denotes a curvature radius of the object-side surface of the third lens; R6 denotes a curvature radius of an image-side surface of the third lens; and TTL denotes a total optical length from an object-side surface of the first lens to an image plane of the camera optical lens along an optic axis.

7. The camera optical lens as described in claim 1, wherein the camera optical lens satisfies:
0.24≤f4/f≤2.73; and
0.02≤d7/TTL≤0.11,
where f4 denotes a focal length of the fourth lens; d7 denotes an on-axis thickness of the fourth lens; and TTL denotes a total optical length from an object-side surface of the first lens to an image plane of the camera optical lens along an optic axis.

8. The camera optical lens as described in claim 1, wherein the camera optical lens satisfies: f/TTL≥1.06, where TTL denotes a total optical length from an object-side surface of the first lens to an image plane of the camera optical lens along an optic axis.

9. The camera optical lens as described in claim 1, wherein the camera optical lens satisfies: 0.33≤f12/f≤1.18, where f12 denotes a combined focal length of the first lens and the second lens.

10. The camera optical lens as described in claim 1, wherein the first lens is made of a glass material.
